(19) United States
(12) Patent Application Publication
(10) Pub. No.: US 2001/0053754 A1
(43) Pub. Date: Dec. 20, 2001

(54) Water soluble package of liquid cleaning composition

(75) Inventors: Malcolm Hewitt, Merseyside (GB); Hannah Mansfield, Merseyside (GB); Neeraj Gupta, Merseyside (GB); James Dawson Cropper, Merseyside (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 09/834,026

(22) Filed: Apr. 12, 2001

(30) Foreign Application Priority Data
Apr. 14, 2000 (GB) 0009340.1
Feb. 23, 2001 (GB) 0104551.7

(51) Int. Cl. C11D 17/08

(52) U.S. Cl. 510/293; 510/439; 510/296; 510/407

(57) ABSTRACT

A water soluble package in the form of a horizontal form-fill-seal envelope formed from a plastics film, the package containing a substantially non-aqueous liquid detergent composition having a viscosity of from 25 to 10,000 mPaS.

### TECHNICAL FIELD

The invention relates to a water soluble package for containing a liquid cleaning composition.

### BACKGROUND TO THE INVENTION

Water soluble packages are known in the detergent and agrochemical industries and generally comprise either vertical form-fill-seal (VFFS) envelopes or thermoformed envelopes. In one of the VFFS processes, a roll of water soluble film is sealed along its edges to form a tube, which tube is heat sealed intermittently along its length to form individual envelopes which are filled with product and heat sealed. The thermoforming process generally involves molding a first sheet of water soluble film to form one or more recesses adapted to retain a composition, such as for example a solid agrochemical composition, placing the composition in the at least one recess, placing a second sheet of water soluble material over the first so as to cover the or each recess, and heat sealing the first and second sheets together at least around the recesses so as to form one or more water soluble packages.

Cleaning products are traditionally often liquids, viscous or thin, such as known for personal cleaning (bath and shower liquids and shampoos) or for domestic cleaning (hand dish wash and other hard surface cleaning, laundry-cleaning etc.). Other products are solids, such as powders, granules, small capsules (up to 2 mm diameter) or more recently tablets, for laundry and machine dish wash, and soap bars for skin cleaning. Recently, so called unit dose products are experiencing an increasing success with consumers, because they eliminate the need for manipulating, and possibly spilling, liquids or powders and simplify the use of a correct dose of the cleaning product for the required purpose. Examples thereof are the laundry and machine dish wash tablets mentioned above and recently described in F. Schambil and M. Böcker, Tenside Surf.Det. 37 (2000) 1.

The present invention is directed to an encapsulated liquid cleaning composition formed by a horizontal form-fill-seal (HFFS) process. However, an alternative aspect of the invention is directed to a VFFS variant.

### PRIOR ART

Many types of water soluble packages are known, including packages made from polyvinyl alcohol (PVOH) film. A wide variety of different materials can be packaged in such films, including liquid materials. EP-A-518689 discloses a containerisation system for hazardous materials (for example pesticides) comprising a PVOH film enclosing a composition comprising the hazardous material, water, an electrolyte and optional other materials. The electrolyte is added to reduce the solubility of the film to prevent its dissolution by the packaged composition.

EP-B-389513 discloses concentrated aqueous syrups (mainly foodstuffs but other materials such as detergents are mentioned) inside PVOH packages, the concentration of the syrup being effective to prevent dissolution of the package by the packaged composition.

EP-A-700989 discloses a unit packaged detergent for dish washing, the package comprising a detergent composition wrapped in PVOH film, wherein the film protects the detergent from dissolution until the main wash cycle of the dish washing machine.

WO-A-97/27743 discloses an agrochemical composition packaged in a water soluble sachet, which can be PVOH.

GB-A-2118961 discloses bath preparations packaged in PVOH film while EP-B-347221 relates to water-soluble sachets of phytosantary materials which are packaged in a secondary water-insoluble pack with a humid environment being maintained between the two.

EP-A-593952 discloses a water soluble sachet of PVOH with two chambers and a treatment agent for washing inside each chamber.

EP-A-941939 relates to a water soluble package, which can be PVOH, containing a composition which, when dissolved, produces a solution of known composition.

GB-A-2305931 discloses a dissolvable laundry sachet and BE-9700361 relates to a water soluble unit-dosed cleaning agent, especially for cleaning hands.

DE-U-29801621 discloses a water soluble unit dose for dishwashing machines.

EP-B-160254 relates to a washing additive comprising a mixture of detergent constituents in a PVOH bag. The detergent comprises nonionic surfactant and a quaternary ammonium compound.

US-4846992 discloses a double-packaged laundry detergent wherein the inner package is water-soluble and can be PVOH.

EP-B-158464 relates to a detergent mull packaged in PVOH and DE-A-19521140 discloses a water soluble PVOH sachet containing a detergent composition.

FR2601930 relates to a water soluble sachet containing any substance, particularly a pharmaceutical.

A variety of water soluble PVOH films are also known. For example, EP-B-157162 relates to a self-supporting film comprising a PVOH matrix having rubbery microdomains dispersed therein.

WO-A-96/00251 relates to an amphipathic graft copolymer comprising a hydrophobic backbone with grafting sites to which are grafted a hydrophilic polymer prepared from a hydrophilic monomer containing stabilising pH independent ionic groups.

GB-B-2090603 relates to a water soluble film comprising a uniform mixture of partially hydrolysed polyvinyl acetate and polyacrylic acid.

WO-A-97/00282 relates to a water soluble film combining two polymeric ingredients S and H where S is a soft acid-functional olefinic addition copolymer having a Tg less than 20 C and H is a hard acid-functional olefinic addition copolymer having a Tg less than 5 40 C. The ratio of S:H is from 90:10 to 65:35 and the acid functionalities are at least partially neutralised to render the film water soluble.

EP-B-79712 relates to a laundry additive for discharge to a wash containing borate ions. The additive is enclosed within a film of PVOH which is plasticised and has as a solubiliser either a polyhydroxy compound (such as sorbitol) or an acid (such as polyacrylic acid).

EP-B-291198 relates to a water soluble film containing an alkaline or borate-containing additive. The film is formed from a copolymer resin of vinyl alcohol having 0-10 mole % residual acetate groups and 1-6 mole % of a non-hydrolysable anionic comonomer. FR2724388 discloses a water soluble bottle, flask or drum made from PVOH which is plasticised with 13-20% of plasticiser (such as glycerol) and then molded.

The specifications of International Patent Applications WO-A-00/55044, WO-A-00/55045, WO-A-00/55046, WO-A-00/55068, WO-A-00/55069 and WO-A-00/55415 disclose water soluble packages containing a fluid substance (defined as a liquid, gel or paste) which is a horizontal form-fill-seal (HFFS) envelope. These packages comprise a body wall portion having internal volume and which is preferably dome-shaped, formed from a first sheet, and a superposed base wall portion, formed from a second sheet, seded to the body wall portion.

A polyvinyl alcohol package containing a liquid laundry detergent composition comprising from about 10% to about 24% by weight of water (but 3.57% in the sole example) is disclosed in US-A-4 973 416.

We have now found that the viscosity of the liquid composition is critical in avoiding a number of problems which arise during filling and storage of the envelope.

### DEFINITION OF THE INVENTION

Thus, the present invention provides a water soluble package in the form of a horizontal form-fill-seal envelope formed from a plastics film, the package containing a substantially non-aqueous liquid cleaning composition having a viscosity of from 25 to 10,000 mPaS.

A second aspect of the present invention is directed to a water soluble package in the form of a vertical form-fill-seal envelope formed from a plastics film, the package containing a substantially non-aqueous liquid cleaning composition having a viscosity of from 150 to 10,000 mPaS.

The present invention enables a unit dose cleaning product to be manufactured by a horizontal form-fill-seal method without loss of product, without splashing to disrupt sealing of the envelope and without liquid seepage after manufacture.

### DETAILED DESCRIPTION OF THE INVENTION

### Horizontal Form-Fill-Seal Envelopes

Any reference herein to filling refers to complete filling and also partial filling whereby some air or other gas is also trapped in the sealed envelope.

A preferred plastics film is a polyvinyl alcohol film, especially one made of a polyvinyl alcohol copolymer having a comonomer having a carboxylate function.

PVOH can be made by the polymerisation of vinyl acetate, followed by hydrolysis, conveniently by reaction with sodium hydroxide. However, the resulting film has a highly symmetrical, hydrogen-bonded structure and is not readily soluble in cold water. PVOH films which are suitable for the formation of water soluble packages are typically polymers produced from copolymerisation of vinyl acetate and another comonomer which contains a carboxylic function. Examples of such comonomers include monocarboxylates, such as acrylic acid, and dicarboxylates, such as itaconic acid, which may be present during polymerisation as esters. Alternatively, the anhydride of maleic acid may be used as the copolymer. The inclusion of the comonomer reduces the symmetry of and degree of hydrogen bonding in the final film and renders the film soluble even in cold water.

Suitable PVOH films for use in a package according to the invention are commercially available and described, for example, in EP-B-0291198. PVOH films for use in a package according to the invention can be made by the copolymerisation of vinyl acetate and a carboxylate-containing monomer (for example acrylic, maleic or itaconic acid or acid ester), followed by partial (for example up to about 90%) hydrolysis with sodium hydroxide.

Water soluble PVOH packages of the invention can be made according to any of the methods horizontal form-fill-seal described in any of WO-A-00155044, WO-A-00155045, WO-A-00/55046, WO-A-00/55068, WO-A-00/55069 and WO-A-00/55415.

By way of example, a thermoforming process is now described where a number of packages according to the invention are produced from two sheets of water soluble material. In this regard recesses are formed in the film sheet using a forming die having a plurality of cavities with dimensions corresponding generally to the dimensions of the packages to be produced. Further, a single heating plate is used for thermoforming the film for all the cavities, and in the same way a single sealing plate is described.

A first sheet of polyvinyl alcohol film is drawn over a forming die so that the film is placed over the plurality of forming cavities in the die. In this example each cavity is generally dome shape having a round edge, the edges of the cavities further being radiussed to remove any sharp edges which might damage the film during the forming or sealing steps of the process. Each cavity further includes a raised surrounding flange. In order to maximise package strength; the film is delivered to the forming die in a crease free form and with minimum tension. In the forming step, the film is heated to 100 to 120° C., preferably approximately 110° C., for up to 5 seconds, preferably approximately 700 micro seconds. A heating plate is used to heat the film, which plate is positioned to superpose the forming die. During this preheating step, a vacuum of 0.5 bar is pulled through the pre-heating plate to ensure intimate contact between the film and the pre-heating plate, this intimate contact ensuring that the film is heated evenly and uniformly (the extent of the vacuum is dependant of the thermoforming conditions and the type of film used, however in the present context a vacuum of less than 0.6 bar was found to be suitable) Non-uniform heating results in a formed package having weak spots. In addition to the vacuum, it is possible to blow air against the film to force it into intimate contact with the preheating plate.

The thermoformed film is molded into the cavities blowing the film off the heating plate and/or by sucking the film into the cavities thus forming a plurality of recesses in the film which, once formed, are retained in their thermoformed orientation by the application of a vacuum through the walls of the cavities. This vacuum is maintained at least until the packages are sealed. Once the recesses are formed and held in position by the vacuum, a liquid composition according to the invention is added to each of the recesses. A second sheet of polyvinyl alcohol film is then superposed on the first sheet across the filled recesses and heat-sealed thereto using a sealing plate. In this case the heat sealing plate, which is generally flat, operates at a temperature of about 140 to 160° C., and contacts the films for 1 to 2 seconds and with a force of 8 to 30kg/cm², preferably 10 to 20 kg/cm². The raised flanges surrounding each cavity ensure that the films are sealed together along the flange to form a continuous seal. The radiussed edge of each cavity is at least partly formed by a resiliently deformable material, such as for example silicone rubber. This results in reduced force being applied at the inner edge of the sealing flange to avoid heat/pressure damage to the film.

Once sealed, the packages formed are separated from the web of sheet film using cutting means. At this stage it is possible to release the vacuum on the die, and eject the formed packages from the forming die. In this way the packages are formed, filled and sealed while nesting in the forming die. In addition they may be cut while in the forming die as well.

During the forming, filling and sealing steps of the process, the relative humidity of the atmosphere is controlled to ca. 50% humidity. This is done to maintain the heat sealing characteristics of the film. When handling thinner films, it may be necessary to reduce the relative humidity to ensure that the films have a relatively low degree of plasticisation and are therefore stiffer and easier to handle.

### Vertical Foam-Fill-Seal Envelopes

In the vertical form-fill-seal (VFFS) technique, a continuous tube of flexible plastics film is extruded. It is sealed, preferably by heat or ultrasonic sealing, at the bottom, filled with the liquid composition, sealed again above the liquid film and then removed from the continuous tube, e.g. by cutting.

### The Substantially Non-Aqueous Liquid Cleaning Composition

The substantially non-aqueous liquid cleaning composition must contain at least one non-aqueous liquid. Further, the non-aqueous liquid itself and/or another component of the composition must provide a cleaning function when released into the wash liquor.

By “substantially non-aqueous” it is meant that that the amount of water in the liquid composition is below the level at which the package would dissolve through contact with its contents. Preferably, the liquid composition comprises 25%, e.g. no more than 20%, more preferably no more than about 15%, still more preferably no more from 10%, such as no more than about 7%, even more preferably no more than about 5% and most preferably no more than from about 3% to about 4%, by weight water. However, in some cases, it may be possible (whether by reason of the thickness of the film used, the physical properties, such as viscosity, of the liquid composition or otherwise) to use even higher quantities of water in the liquid composition inside the package according to the invention, although these should never exceed 50% by weight of the liquid composition.

The substantially non-aqueous liquid composition may be substantially Newtonion or else non-Newtonion in rheology. The latter especially applies when the composition comprises dispersed solids. Therefore, for the avoidance of doubt, all viscosities expressed herein are measured at a shear rate of 21 s⁻¹.

The viscosity of the composition is from 25 mPaS, 50 mPaS, 75 mPaS or 100 mPaS, preferably 125 mPaS, more preferably 150 mPaS to 10,000 mPaS, for example above 150 mPaS but no more than 10,000 mPaS. The alternative embodiment of the invention relates to VFFS encapsulation in which case, the minimum viscosity must be 150 mPaS, for example above 150 mPaS.

The composition may be considered as falling into the sub-classes of thin liquids, thick liquids, and gels/pastes.

The thin liquids may have a minimum viscosity of 25, 50, 75, 100, 125, 150 mPaS or above 150 mPaS for example 175 mPaS, preferably 200 mPaS. They may for example have a maximum viscosity of 500 mPaS preferably 450 mPaS more preferably 400 mPaS or even 250 mPaS.

The thick liquids may have a minimum viscosity of 400 mPaS, for example 350 mPaS, or even 300 mPaS and a maximum viscosity of 1,500 mPaS, preferably 1,200 mPaS.

The gels or pastes may have a minimum viscosity of 1,400 mPaS, for example 1,500 mPaS, preferably 1,750 mPaS, 2000 mPaS, 2,500 mPaS, 3,000 mPaS or even 3,500 mPaS. Their maximum viscosity may be 10,000 mPaS, preferably 9,000 mPaS, more preferably 8,000 mPaS, 7,500 mPaS or even 4,000 mPaS.

The non-aqueous liquid may comprise one or more non-aqueous liquid components.

These may be one or more liquid surfactants and/or one or more non-aqueous non-surfactant liquids.

One suitable class of liquid surfactants comprises liquid nonionic surfactants.

Nonionic detergent surfactants are well-known in the art. They normally consist of a water-solubilizing polyalkoxylene or a mono- or d-alkanolamide group in chemical combination with an organic hydrophobic group derived, for example, from alkylphenols in which the alkyl group contains from about 6 to about 12 carbon atoms, dialkylphenols in which primary, secondary or tertiary aliphatic alcohols (or alkyl-capped derivatives thereof), preferably having from 8 to 20 carbon atoms, monocarboxylic acids having from 10 to about 24 carbon atoms in the alkyl group and polyoxypropylense. Also common are fatty acid mono- and dialkanolamides in which the alkyl group of the fatty acidradical contains from 10 to about 20 carbon atoms and the alkyloyl group having from 1 to 3 carbon atoms. In any of the mono- and di-alkanolamide derivatives, optionally, there may be a polyoxyalkylene moiety joining the latter groups and the hydrophobic part of the molecule. In all polyalkoxylene containing surfactants, the polyalkoxylene moiety preferably consists of from 2 to 20 groups of ethylene oxide or of ethylene oxide and propylene oxide groups. Amongst the latter class, particularly preferred are those described in the applicants' published European specification EP-A-225,654, especially for use as all or part of the solvent. Also preferred are those ethoxylated nonionics which are the condensation products of fatty alcohols with from 9 to 15 carbon atoms condensed with from 3 to 11 moles of ethylene oxide. Examples of these are the condensation products of C₁₁₋₁₃ alcohols with (say) 3 or 7 moles of ethylene oxide. These may be used as the sole nonionic surfactants or in combination with those of the described in the last-mentioned European specification, especially as all or part of the solvent.

Another class of suitable nonionics comprise the alkyl polysaccharides (polyglycosides/oligosaccharides) such as described in any of specifications U.S. Pat. Nos. 3,640,998; 3,346,558; 4,223,129; EP-A-92,355; EP-A-99,183; EP 70,074, '75, '76, '77; EP 75,994, '95, '96.

Nonionic detergent surfactants normally have molecular weights of from about 300 to about 11,000. Mixtures of different nonionic detergent surfactants may also be used, provided the mixture is liquid at room temperature.

Suitable non-aqueous non-surfactant liquids forms can be used alone or with in combination with liquid surfactants. Non-surfactant solvents which are more preferred category include ethers, polyethers, alkylamines and fatty amines, (especially di- and tri-alkyl-and/or fatty-N-substituted amines), alkyl (or fatty) amides and mono- and di- N-alkyl substituted derivatives thereof, alkyl (or fatty) carboxylic acid lower alkyl esters, ketones, aldehydes, polyols, and glycerides. Specific examples include respectively, di-alkyl ethers, polyethylene glycols, alkyl ketones (such as acetone) and glyceryl trialkylcarboxylates (such as glyceryl tri-acetate), glycerol, propylene glycol, and sorbitol.

Other suitable solvents are lower (C₁₋₄) alcohols, such as ethanol, or higher (C₅₋₉) alcohols, such as hexanol, as well as alkanes and olefins. However, they can be combined with other solvent materials which are surfactants and non-surfactants having the aforementioned “preferred” kinds of molecular structure. Even though they appear not to play a role in the deflocculation process, it is often desirable to include them for lowering the viscosity of the product and/or assisting soil removal during cleaning.

Preferably, the compositions of the invention contain the organic solvent (whether or not comprising liquid surfactant) in an amount of at least 10% by weight of the total composition. The amount of the solvent present in the composition may be as high as about 90%, but in most cases the practical amount will lie between 20 and 70% and sometimes, between 20 and 50% by weight of the composition. The weight ratio of surfactant to non-surfactant non-aqueous liquid components is preferably from 0:10 to 10:0, more preferably from 1:10 to 10:1, still more preferably from 1:6 to 6:1, yet more preferably from 1:5 to 5:1, e.g. from 1:3 to 3:1.

Whether or not the composition comprises nonionic surfactant, one or more other surfactants may be present. These may be in liquid form or as solid dissolved or dispersed in the substantially non-aqueous liquid component. They may be selected from anionic, cationic and ampholytic detergent surfactants. The anionic surfactants may be incorporated in free acid and/or neutralised from. The cationic surfactant may be neutralised with a counter ion or it may be used to neutralise the at least one ionic ingredient with an exchangeable hydrogen ion.

The composition may also comprise one or more solid dissolved and/or dispersed in the substantially non-aqueous liquid. When these are dispersed solids, it is preferred also to include one or more deflocculating agents as described in EP-A-0 266 199.

Some of these ingredients may be of an acidic nature, such as soaps or the acid precursors of anionic surfactants (which can be used for their surfactant properties and/or as deflocculants). These materials have an exchangeable hydrogen ion. In the case where the capsule comprises a material made of polyvinyl alcohol copolymer having a comonomer with a carboxylate function, this can lead to a problem.

When the plastics film of the envelope is a copolymer film containing polyvinyl alcohol and monomer units comprising carboxylic acid (or carboxylate) groups in proximity to hydroxyl groups on the same carbon chain and there is an attendant drive towards cyclisation of these groups by water elimination to form lactones. A low level of lactone formation is desirable to improve the mechanical properties of the film. However, the formation of excessive amounts of lactones is undesirable as this tends to reduce the cold water solubility of the film, giving rise to a danger of undissolved film residues when the package is used.

The problem of excessive lactone formation is particularly acute when the liquid composition inside the package comprises ionic species having an exchangeable hydrogen ion, for example fatty acids or the acid precursors of anionic surfactants. This problem may be solved by including in the composition, a stabilising compound effective for combining with the exchangeable hydrogen ions to hinder the formation of lactones within the film. This stabilising compound should preferably be in molar excess relative to the component(s) having an exchangeable ion. This molar excess is preferably 105 mole %, preferably 110 mole % of the stoichiometric amount necessary for complete neutralisation. It is preferably an organic base such as one or more amines, e.g. monoethanolamine, triethanolamine and mixtures thereof. When the stabilising compound is an inorganic base such as an alkali metal (e.g. sodium or potassium) hydroxide, or ammonium hydroxide, it may, however, present in an amount of from 95 mole % to 105 mole % relative to the component(s) having an exchangeable hydrogen

In other aspects of the invention, for the stabilising compound, instead of the 95 mole %, we may claim as minimum, any of 90, 91, 92, 93, 94, 94.4, 96, 96.5, 97, 97.5, 98, 98.5, 99 and 99.5 mole %. Also, independently of any particular minimum, in other aspects of the invention, as maximum, we may claim any of 100.25, 100.5, 101, 101.5, 102, 102.5, 103, 103.5, 104, 105, 106, 107, 108, 109 and 110 mole %.

Other possible stabilising compounds are alkaline earth metal hydroxides or other inorganic bases which do liberate water on protonation. These are preferably also used in an amount indicated above for the alkali metal hydroxides and ammonium hydroxide.

Yet other suitable stabilising compounds are amines other than monoethanolamine and triethanolamine, organic Lewis bases or other organic or inorganic bases provided that they will interact effectively with labile protons within the detergent composition to hinder the production of lactones in the film.

When the stabilising agent is used with a PVOH comonomer package as described above, it provides an advantage in relation to the avoidance of film residues being left on clothes. By preserving the cold water solubility of the film the invention helps to ensure that even when the package of the invention becomes trapped within the laundry load such that there is only restricted water in contact with the film to dissolve it, dissolution is still sufficiently rapid such that there will be no or minimal residues at the end of the wash cycle.

When present, the ionic ingredient with exchangeable hydrogen ions may, for example, constitute from between 1% and 40% (prior to any neutralisation) by weight of the total substantially non-aqueous liquid composition. When used primarily for their surfactant properties, such ingredients may for example be present in amounts greater than 10% by weight. When used as deflocculants (see below), the amounts may be 10% by weight or less, e.g. no more than 5% by weight. These ingredients may for example be selected from anionic surfactant acid precursors and fatty acids and mixtures thereof.

Anionic surfactant acids are well known to those skilled in the art. Examples suitable for use in a liquid composition according to the invention include alkylbenzene sulphonic acid, particularly C₈₋₁₅ linear alkylbenzene sulphonic acids and mixtures thereof. Other suitable surfactant acids include the acid forms of olefin sulphonates, alkyl ether sulphates, alkyl sulphates or alkane sulphonates and mixtures thereof.

A wide range of fatty acids are suitable for inclusion in a liquid composition according to the invention, for example selected from one or more C₈₋₂₄ alkyl or alkenyl monocarboxylic acids. Saturated or unsaturated fatty acids may be used. Examples of suitable fatty acids include oleic acid, lauric acid or hardened tallow fatty acid.

### Other Components

The laundry treatment agent according to the invention may further comprise one or more ingredients selected from non-ionic or cationic surfactants, builders, polymers, fluorescers, enzymes, silicone foam control agents, perfumes, dyes, bleaches and preservatives.

Some of these materials will be solids which are insoluble in the substantially non-aqueous liquid medium. In that case, they will be dispersed in the substantially non-aqueous liquid medium and may be deflocculated by means of one or more acidic components such as selected from inorganic acids anionic surfactant acid precursors and Lewis acids, as disclosed in EP-A-266 199, as mentioned above.

### Unit Dose Volume

The amount of the substantially non-aqueous liquid cleaning composition is each unit dose envelope may for example be from 10 ml to 100 ml, e.g. from 12.5 mi to 75 mi, preferably from 15 mi to 60 ml, more preferably from 20 ml to 55 ml.

### EXAMPLE

The invention will now be more particularly described with reference to specific example and Table 1.

A liquid detergent composition according to the invention was prepared as follows. The following ingredients were taken:

TABLE I

| | |
|---|---|
| Nonionic (Neodol C11. 5EO) | 26% |
| LAS acid | 20% |
| Priolene 6907 fatty acid | 13% |
| Glycerol | 20% |
| Perfume | 1% |
| Enzymes + polymer | 2% |
| Monopropylene glycol | 7% |
| Monoethanolamine | 7.6% |
| Water | Balance |

The viscosity of this composition was 647 mPaS. This was filled at a dose of 25 ml into a horizontal form-fill envelope of polyvinyl alcohol/carboxylate monomer film. It was found to fill the envelope with ease, without splashing and without subsequent leakage.

1. A water soluble package in the form of a horizontal form-fill-seal envelope formed from a plastics film, the package containing a substantially non-aqueous liquid cleaning composition having a viscosity of from 25 to 10,000 mPaS.

2. A water soluble package according to claim 1, wherein the viscosity of the substantially non-aqueous liquid cleaning composition is from 50 mPaS, 75 mPaS or 100 mPaS, preferably 125 mPaS, more preferably 150 mPaS to 10,000 mPaS, for example above 150 mPaS but no more than 10,000 mPaS.

3. A water soluble package according to either preceding claim, wherein the substantially non-aqueous liquid cleaning composition is in the form of a thin liquid having a minimum viscosity of 25, 50, 75, 100, 125, 150 mPaS or above 150 mPaS for example 175 mPaS, preferably 200 mPaS, and a maximum viscosity of 500 mPaS preferably 450 mPaS more preferably 400 mPaS, still more preferably 250 mPaS.

4. A water soluble package according to claim 1 or claim 2, wherein the substantially non-aqueous liquid cleaning composition is in the form of a thick liquid having a minimum viscosity of 400 mPaS, for example 350 mPaS, or even 300 mPaS and a maximum viscosity of 1,500 mPaS, preferably 1,200 mPaS.

5. A water soluble package according to claim 1 or claim 2, wherein the substantially non-aqueous liquid cleaning composition is in the form of a gel or paste having a minimum viscosity of 1,400 mPaS, for example 1,500 mPaS, preferably 1,750 mPaS, 2000 mPaS, 2,500 mPaS, 3,000 mPaS or even 3,500 mPaS, and a maximum viscosity may be 10,000 mPaS, preferably 9,000 mPaS, more preferably 8,000 mPaS, 7,500 mPaS or even 4,000 mPaS.

6. A water soluble package according to any preceding claim, wherein the plastics film comprises a polyvinyl alcohol polymer or copolymer.

7. A water soluble package according to claim 6, wherein the envelope is formed from a polyvinyl alcohol comonomer having carboxylate functionality.

8. A water soluble package according to claim 7, wherein the substantially non-aqueous liquid cleaning composition comprises at least one ionic ingredient with an exchangeable hydrogen ion; and a stabilising compound effective for combining with the exchangeable hydrogen ions to hinder formation of lactones, especially β-lactones within the film.

9. A water soluble package according to claim 8, wherein the stabilising compound comprises an organic base, preferably an amine.

10. A water soluble package according to claim 9, wherein the stabilising compound is in a molar excess with respect to the amount of the ionic ingredient having exchangeable hydrogen ions, preferably at least 105 mole %, more preferably at least 110 mole % of the stoichiometric amount necessary for complete neutralisation of the ionic ingredient.

11. A water soluble package according to claim 8, wherein the stabilising compound is selected from one or more inorganic or ammoniacal bases, preferably an alkali metal hydroxide, alkaline earth metal hydroxides and ammonium hydroxide.

12. A water soluble package according to claim 11, wherein the amount of the stabilising agent relative to the amount of the ionic ingredients having exchangeable hydrogen ions is from 95 mole % to 105 mole %, preferably from 95 mole % to 102 mole % relative to the stoichiometric amount to effect complete neutralisation of the ionic ingredient.

13. A water soluble package according to any preceding claim, wherein the liquid composition is a laundry treatment agent.

14. A water soluble package according to claim 13, wherein the at least one ionic ingredient comprises an anionic surfactant acid.

15. A water soluble package according to claim 13 or claim 14, wherein the at least one ionic ingredient comprises a fatty acid soap.

16. A water soluble package in the form of a vertical form-fill-seal envelope formed from a plastics film, the package containing a substantially non-aqueous liquid cleaning composition having a viscosity of from 150 to 10,000 mPaS.

17. A water soluble package according to any preceding claim, wherein the substantially non-aqueous liquid cleaning product comprises a cationic surfactant.
